(19) United States
(12) Patent Application Publication
(10) Pub. No.: US 2016/0026514 A1
(43) Pub. Date: Jan. 28, 2016

(54) STATE MIGRATION FOR ELASTIC VIRTUALIZED COMPONENTS

(71) Applicants: Tommaso Cucinotta, Dublin (IE); Andrea Meroni, Pavia (IT); Volker Hilt, Waiblingen Hegnach (DE)

(72) Inventors: Tommaso Cucinotta, Dublin (IE); Andrea Meroni, Pavia (IT); Volker Hilt, Waiblingen Hegnach (DE)

(73) Assignee: ALCATEL LUCENT, Boulogne-Billancourt (FR)

(21) Appl. No.: 14/338,502

(22) Filed: Jul. 23, 2014

(51) Int. Cl. G06F 9/54; G06F 9/50

(52) U.S. Cl. CPC G06F 9/546; G06F 9/5088

(57) ABSTRACT

A capability for supporting an elastic virtualized component that is stateful is provided by supporting state migration for the elastic virtualized component. The elastic virtualized component may support a virtualized network function or any other suitable virtualized function. The elastic virtualized component includes a component load balancer and a set of component instances configured to provide functions of the elastic virtualized component. The elastic virtualized component may be configured to support migration of state information of the component instances following elasticity events in which the capacity of the elastic virtualized component changes (e.g., in response to growth events in which the number of component instances of which the elastic virtualized component is composed increases, in response to degrowth events in which the number of component instances of which the elastic virtualized component is composed decreases, or the like).

### TECHNICAL FIELD

The disclosure relates generally to elastic virtualized components and, more specifically but not exclusively, to state migration for elastic virtualized components.

### BACKGROUND

The use of virtual components to support virtualization of various types of functions, including network functions, continues to grow. Many virtual functions need to be implemented as stateful functions. Additionally, when realizing various types of virtual functions, including network functions, it may be necessary or desirability to support elasticity of the virtualized components used to provide the virtual functions. Thus, a need exists to support stateful, elastic virtualized components.

### SUMMARY OF EMBODIMENTS

Various deficiencies in the prior art are addressed by embodiments for supporting processing of messages by an elastic virtualized component.

In at least some embodiments, an apparatus is configured to support an elastic virtualized component. The apparatus includes a processor and a memory communicatively connected to the processor. The processor is configured to receive, at a first component instance of the elastic virtualized component, a message to be processed by the first component instance. The received message includes information indicative that state information associated with the received message is stored by a second component instance of the elastic virtualized component. The processor is configured to propagate, from the first component instance toward the second component instance, a state information request message configured to request migration of the state information from the second component instance to the first component instance.

In at least some embodiments, a method for supporting an elastic virtualized component is provided. The method includes receiving, at a first component instance of the elastic virtualized component, a message to be processed by the first component instance. The received message includes information indicative that state information associated with the received message is stored by a second component instance of the elastic virtualized component. The method includes propagating, from the first component instance toward the second component instance, a state information request message configured to request migration of the state information from the second component instance to the first component instance.

In at least some embodiments, an apparatus configured to support propagation of messages for processing by an elastic virtualized component. The apparatus includes a processor and a memory communicatively connected to the processor. The processor is configured to receive a message intended for processing by the elastic virtualized component, where the elastic virtualized component includes a set of virtual component instances. The processor is configured to select a first component instance of the elastic virtualized component for the received message. The processor is configured to modify the received message, based on a determination that state information associated with the received message is stored by a second component instance of the elastic virtualized component, to form a modified message including information indicative of the second component instance storing the state information associated with the received message. The processor is configured to propagate the modified message toward the first component instance.

In at least some embodiments, a method for supporting processing of messages by an elastic virtualized component is provided. The method includes receiving, by a processor, a message intended for processing by the elastic virtualized component where the elastic virtualized component includes a set of component instances, selecting a first component instance of the elastic virtualized component for the received message, modifying the received message, based on a determination that state information associated with the received message is stored by a second component instance of the elastic virtualized component, to form a modified message including information indicative of the second component instance storing the state information associated with the received message, and propagating the modified message toward the first component instance.

### BRIEF DESCRIPTION OF THE DRAWINGS

The teachings herein can be readily understood by considering the following detailed description in conjunction with the accompanying drawings, in which:

FIG. 1 depicts an exemplary system including an elastic virtualized component;

FIG. 2 depicts a process for supporting state migration for the elastic virtualized component of FIG. 1 following an elasticity event which changes the capacity of the elastic virtualized component of FIG. 1;

FIG. 3 depicts an exemplary system including the elastic virtualized component of FIG. 1 and an external element configured for supporting migration of state information of the elastic virtualized component of FIG. 1; and

FIG. 4 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

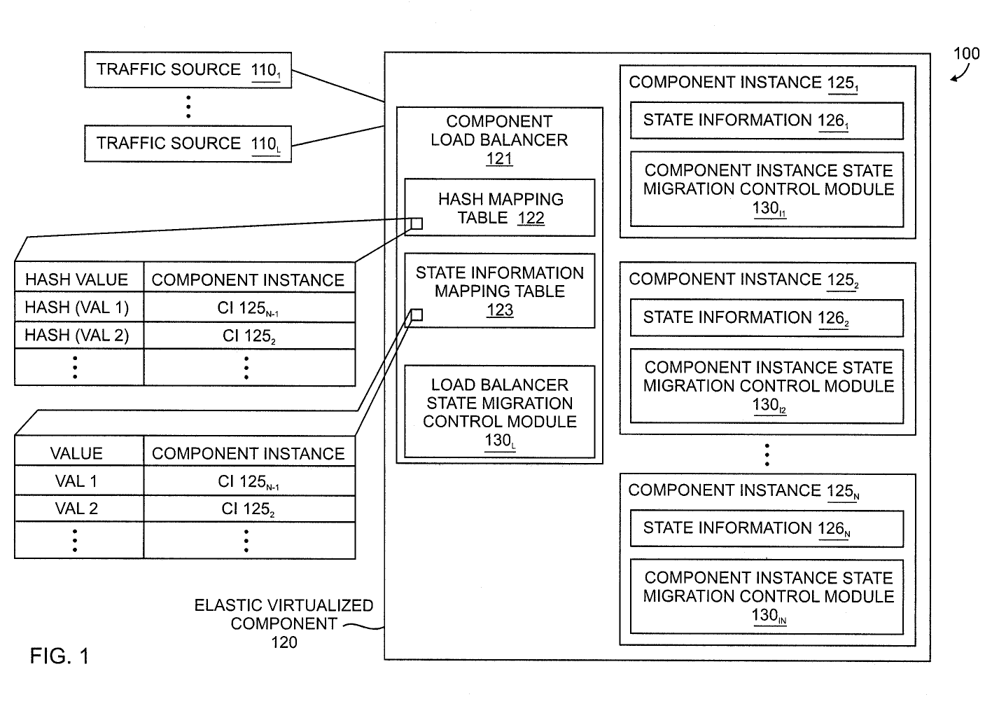

A capability for supporting an elastic virtualized component that is stateful is provided by supporting state migration for the elastic virtualized component. The elastic virtualized component may support a virtualized network function or any other suitable virtualized function. The elastic virtualized component is provided by a set of component instances (e.g., virtual machine (VM) instances or other suitable component instances). The elastic virtualized component may be configured to support migration of state information of the component instances following elasticity events in which the capacity of the elastic virtualized component changes (e.g., in response to growth events in which the number of component instances of which the elastic virtualized component is composed increases, in response to degrowth events in which the number of component instances of which the elastic virtualized component is composed decreases, or the like). Various embodiments of the capability for handling state migration for an elastic virtualized component may be better understood by considering an exemplary system including an elastic virtualized component, as depicted in FIG. 1.

FIG. 1 depicts an exemplary system including an elastic virtualized component.

The system 100 includes a set of traffic sources 110₁-110_{L} (collectively, traffic sources 110) and an elastic virtualized component 120. The elastic virtualized component 120 includes a component load balancer 121 and a set of component instances 125₁-125_{N} (collectively, component instances 125).

The traffic sources 110 may include any elements configured to produce traffic intended for handling by elastic virtualized component 120. For example, traffic sources 110 may include user devices (e.g., one or more of a thin client, a smartphone, a tablet computer, a laptop computer, a desktop computer, or the like), connected end devices (e.g., smart devices, Internet of Things (loT) devices, or the like), network devices (e.g., routers, switches, servers, functions, or the like), virtualized functions, or the like, as well as various combinations thereof). The traffic sources 110 may communicate with elastic virtualized component 120 via any communication network(s) suitable for transporting traffic (e.g., wireline networks, wireless networks, cable-based access networks, Wireless Fidelity (WiFi)-based access networks, cellular access networks, core networks, or the like, as well as various combinations thereof). The traffic sources 110 access elastic virtualized component 120 via the component load balancer 121. It will be appreciated that, although depicted and described with respect to traffic sources 110 that are located outside of elastic virtualized component 120, one or more traffic sources that produce traffic for elastic virtualized component 120 may be located within elastic virtualized component 120.

The elastic virtualized component 120 is configured to provide a function or set of functions. The elastic virtualized component 120 may be a standalone component or may form part of a virtualized function that includes a set of virtualized components providing respective functions or sets of functions associated with providing the overall functionality of the virtualized function. For example, elastic virtualized component 120 may be a cloud-based file system for a user or group of users. For example, elastic virtualized component 120 may be a voicemail application or may form part of a voicemail application (e.g., such as where elastic virtualized component 120 is configured to play announcements, record messages left for subscribers, play messages left for subscribers, or the like). For example, elastic virtualized component 120 may be part of a virtualized network function supporting virtualization of a Long Term Evolution (LTE) solution (e.g., where elastic virtualized component 120 may be configured to provide functions of a Serving Gateway (SGW), a Packet Data Network (PDN) Gateway (PGW), a Mobility Management Entity (MME), or like LTE elements, as well as various combinations thereof). For example, elastic virtualized component 120 may be part of a virtualized network function supporting virtualization of an Internet Protocol (IP) Multimedia Subsystem (IMS) solution (e.g., where elastic virtualized component 120 may be configured to provide functions of a Proxy—Call Session Control Function (P-CSCF), a Serving—CSCF (S-CSCF), an IMS Presence Server, or like IMS elements, as well as various combinations thereof). It will be appreciated that elastic virtualized component 120 may be configured to support virtualization of various other types of functions or capabilities.

The elastic virtualized component 120 may be hosted within a virtual environment configured to support virtual implementation of elastic virtualized component 120. For example, elastic virtualized component 120 may be hosted using a single datacenter, a set of datacenters, a communication network, a set of communication networks, or the like, as well as various combinations thereof. The virtual environment used to host elastic virtualized component 120 may include various physical resources configured to host virtual resources (which also may be referred to herein as cloud resources) which are used to provide elastic virtualized component 120. For example, the physical resources may include physical computing resources (e.g., processors), physical memory resources, physical storage resources, physical networking resources, or the like, as well as various combinations thereof. For example, the virtual resources may include virtual computing resources, virtual memory resources, virtual storage resources, virtual networking resources, or the like, as well as various combinations thereof. It will be appreciated that various combinations of physical resources of the virtual environment may be used to provide virtual resources within the virtual environment. It will be appreciated that various combinations of virtual resources of the virtual environment may be used to host or provide the component instances 125 of elastic virtualized component 120 (which, accordingly, also may be referred to herein as virtual resource component instances). In at least some embodiments, for example, virtual resources may include virtual machine (VM) instances which may be used to host or provide component instances 125 of elastic virtualized component 120 (which, accordingly, also may be referred to herein as virtual machine (or VM-based) component instances).

The elastic virtualized component 120 is elastic in that the set of component instances 125 of elastic virtualized component 120 may be increased or decreased dynamically as desired or needed. The set of component instances 125 of elastic virtualized component 120 may be expanded by instantiating one or more new component instances 125 for the elastic virtualized component 120 and, similarly, the set of component instances 125 of elastic virtualized component 120 may be contracted by terminating one or more existing component instances 125 of the elastic virtualized component 120. The number of component instances 125 of elastic virtualized component 120 may be increased or decreased in response to various conditions (e.g., based on changing demand over time, based on anticipation or prediction of different demand in the future, receipt of a user-initiated or automatically-initiated request for increased or decreased capacity, or the like, as well as various combinations thereof). The typical manner in which component instances may be dynamically instantiated or terminated will be understood by one of ordinary skill in the art.

The elastic virtualized component 120 is stateful in that state information maintained by elastic virtualized component 120 is used to process related messages (e.g., messages related to the same user, same user interaction, same transaction, same session, or the like, where the relationship upon which state information is based may vary for different functions which may be supported by elastic virtualized component 120). The component load balancer 121, upon receiving a message (e.g., a message from a traffic source 110), determines whether the message is related to any message(s) previously received at elastic virtualized component 120 (and, thus, for which elastic virtualized component 120 may be maintaining state information). The component load balancer 121, upon determining that a received message is not related to any message(s) previously received at elastic virtualized component 120 (and, thus, for which elastic virtualized component 120 is not expected to be maintaining state information), selects one of the component instances 125 to handle the received message and provides the received message to the selected one of the component instances 125. The component load balancer 121 is configured to select one of the component instances 125 to handle a received message based on a load balancing mechanism supported by the component load balancer 121. The component load balancer 121, upon determining that a received message is related to a message(s) previously received at elastic virtualized component 120 (and, thus, for which elastic virtualized component 120 is expected to be maintaining state information), directs the received message in a manner that enables use of the associated state information for processing the received message. However, directing the received message in a manner that enables use of the associated state information for processing the received message, as well as supporting processing of the received message based on the associated state information, is complicated in the case of elasticity (namely, in the case of elastic virtualized component 120 where the set of component instances 125 of the elastic virtualized component 120 may change over time). This is primarily due to the fact that, when the number of component instances 125 increases or decreases dynamically using elasticity, the mapping information that is used by the component load balancer 121 to direct received messages also changes, such that an incoming message related to a previous message may be routed to a component instance 125 that is different than the component instance 125 to which the previous message was routed. The handling of such situations is described in additional detail below.

The component load balancer 121 of elastic virtualized component 120 is configured to support a load balancing mechanism for supporting balancing of load across component instances 125. For purposes of clarity in describing the operation of elastic virtualized component 120, it is assumed that the load balancing mechanism supported by component load balancer 121 is based on a hash computed over at least a portion of a received message (e.g., a field, a combination of multiple fields, the entire message, or the like). For example, where elastic virtualized component 120 is providing a voicemail application, the component load balancer 121 may compute the hash based on the called telephone number included within each message. For example, where elastic virtualized component 120 is providing an LTE SGW function, the component load balancer 121 may compute the hash based on a Tunnel Endpoint Identifier (TEID) included within each message. For example, where elastic virtualized component 120 is providing a SIP function of an IMS environment, the component load balancer 121 may compute the hash based on the value of the From field included within each message. The component load balancer 121 maintains a hash mapping table 122 which includes mappings of sets of hash values to component instances 125 associated with the sets of hash values, respectively. The hash mapping table 122 includes exemplary entries indicating that a first hash value (resulting from hashing of a first value (VAL1)) is associated with the component instance 125_{N-1} (such that received messages including VAL1 in the field over which the hash is computed are to be directed to the component instance 125_{N-1} for processing), a second hash value (resulting from hashing of a second value (VAL2)) is associated with the component instance 125₂ (such that received messages including VAL2 in the field over which the hash is computed are to be directed to the component instance 125₂ for processing), and so forth. The computation of the hash for a message is also based on the number of component instances 125 available within the elastic virtualized component 120 when the message is received (e.g., computed based on modulo N for elastic virtualized component 120, elastic virtualized component 120 includes N component instances 125). As a result, as indicated above, a change in the number of component instances 125 of elastic virtualized component 120 may result in changes to at least some of the entries of hash mapping table 122. Thus, due to an elasticity event in which the number of component instances 125 of elastic virtualized component 120 increases or decreases dynamically, entries of the hash mapping table 122 may specify different component instances 125 for related messages (e.g., messages including the same value over which the hash is computed) received by elastic virtualized component 120 before and after the elasticity event, respectively. As discussed above, this is problematic in the case of a stateful virtualized component such as elastic virtualized component 120, because state information that is generated at a first component instance 125 based on processing of a message routed to the first component instance 125 before an elasticity event is maintained at the first component instance 125 and, thus, is not available at a second component instance 125 to which a subsequent message is routed after the elasticity event due to a change of hash mapping table 122 responsive to the elasticity event. Accordingly, the component load balancer 121 is configured to maintain a state information mapping table 123 for tracking the component instances 125 to which sets of related messages (namely, sets of related messages where the messages of a given related message set are related through the value that is used by component load balancer 121 for hashing into the set of component instances 125) are routed and, thus, the component instances 125 storing state information 126 for the sets of related messages, respectively. The component load balancer 121 may be configured to maintain mappings between (1) values used to select component instances 125 for handling received messages (via computation of hashes based on those values, as discussed above) and (2) component instances 125 to which received messages are routed for the respective values (and, thus, again, which are storing state information 126 for use in processing subsequent messages including the respective values). The state information mapping table 123 includes exemplary entries indicating that the most recently received message including a first value (VAL1) was provided to component instance 125_{N-1} for processing (and, thus, that state information 126_{N-1} includes state information that is based on processing of the first message including VAL1 and which may be used for processing subsequent messages including VAL1), the most recently received message including a second value (VAL2) was provided to component instance 125₂ for processing (and, thus, that state information 126₂ includes state information that is based on processing of the first message including VAL2 and which may be used for processing subsequent messages including VAL2), and so forth. It will be appreciated that other suitable types of load balancing mechanisms may be used by the component load balancer 121 of elastic virtualized component 120.

The component instances 125 of elastic virtualized component 120 maintain state information 126. This is depicted as state information 126₁-126_{N} maintained on component instances 125₁-125_{N}, respectively. As noted above, when a given component instance 125ᵢ processes a message it stores state information (illustratively, the state information 126ᵢ) for the message, which may be used by the given component instance 125ᵢ for processing subsequent related messages. The component instances 125 may store state information 126 in any suitable manner (e.g., in volatile memory of the component instance 125, in non-volatile memory of the component instances 125, or the like, as well as various combinations thereof). For example, where elastic virtualized component 120 is providing a voicemail application, a request to record a message for a subscriber that is routed to a particular component instance 125 may result in storage, within that component instance 125, of state information 126 which may then be used to process a subsequent request by the subscriber to retrieve the recorded message. For example, where elastic virtualized component 120 is providing an LTE SGW function, a first message associated with a session of a User Equipment (UE) that is routed to a particular component instance 125 may result in storage, within that component instance 125, of state information 126 which may then be used to process a subsequent messages associated with that session for that UE. For example, where elastic virtualized component 120 is providing an IMS Presence Server function, a request by a first subscriber to publish presence information that is routed to a particular component instance 125 may result in storage, within that component instance 125, of state information 126 which may then be used to process subsequent requests by other subscribers to subscribe to the presence information of the first subscriber. The state information 126ᵢ of a given component instance 125ᵢ also may be referred to herein as internal state information of the given component instance 125ᵢ.

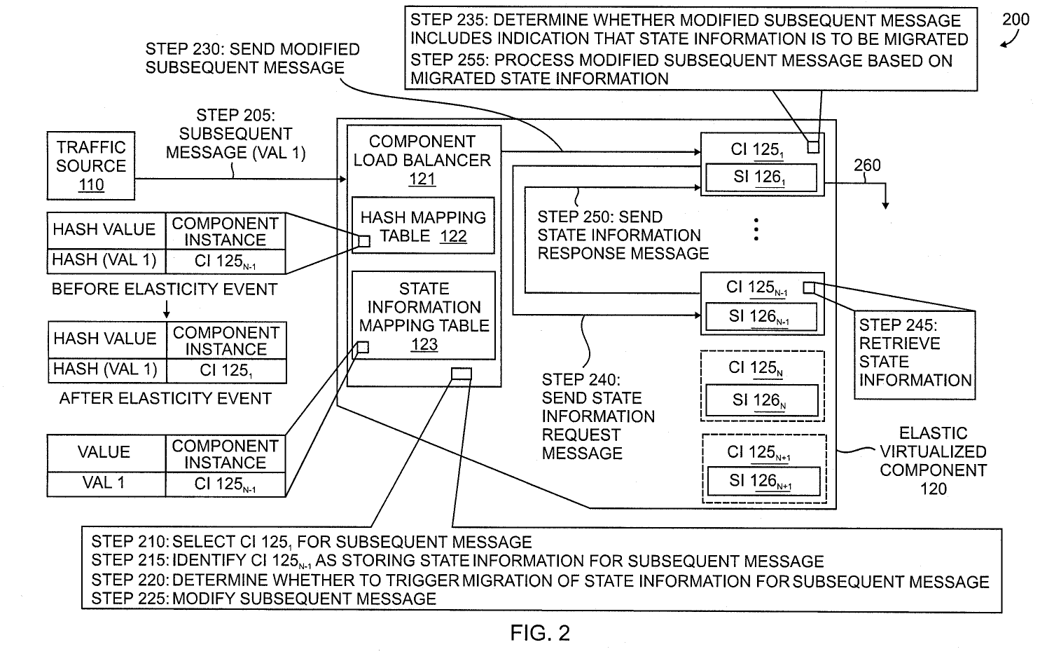

As depicted in FIG. 1, component load balancer 121 includes a load balancer state migration control module 130_{L} and the component instances 125₁-125_{N} include respective component instance state migration control modules 130_{I1}-130_{IN} (collectively, component instance state migration control modules 130_{I}). The load balancer state migration control module 130_{L} and component instance state migration control modules 130_{I} (which may be referred to collectively as state migration control modules 130) may cooperate to support on-demand state migration for elastic virtualized component 120. The operation of state migration control modules 130 for supporting on-demand state migration for elastic virtualized component 120 following an elasticity event resulting in a change in capacity of elastic virtualized component 120 (e.g., a growth event causing an increase in the number of component instances 125 of elastic virtualized component 120 or a degrowth event causing a decrease in the number of component instances 125 of elastic virtualized component 120) is depicted and described with respect to FIG. 2.

FIG. 2 depicts a process for supporting state migration for the elastic virtualized component of FIG. 1 following an elasticity event which changes the capacity of the elastic virtualized component of FIG. 1. As depicted in FIG. 2, process 200 includes message flows as well as processing which may be performed at elements of the elastic virtualized component 120 of FIG. 1. It will be appreciated that, although primarily depicted and described as being performed serially, at least a portion of the steps of process 200 may be performed contemporaneously or in a different order than as presented in FIG. 2.

As depicted in FIG. 2, the capacity of elastic virtualized component 120 has changed responsive to an elasticity event. In the case of a growth event, the capacity of elastic virtualized component 120 may be increased from N component instances 125 to N+1 component instances 125 (or more than N+1 component instances 125 where multiple new component instances 125 are added) via addition of a new component instance 125_{N+1} (namely, the component instances 125₁-125_{N} are considered to be existing component instances of which the elastic virtualized component 120 was composed prior to the growth event, and component instance 125_{N+1} is considered to be a new component instance for elastic virtualized component 120 after the growth event). In the case of a degrowth event, the capacity of elastic virtualized component 120 may be decreased from N component instances 125 to N−1 component instances 125 (or less than N−1 component instances 125 where multiple existing component instances 125 are terminated) via initiation of termination of existing component instance 125_{N} (here, it is indicated that termination of existing component instance 125_{N} is “initiated” since the actual termination of existing component instance 125_{N} and removal of existing component instance 125_{N} from elastic virtualized component 120 may or may not be performed immediately). In either case, the change in the set of component instances 125 available at elastic virtualized component 120 for selection by component load balancer 121 has changed, thereby resulting in a change in distribution of received messages across the set of component instances 125 by the component load balancer 121 at the elastic virtualized component 120, as discussed further below.

In describing the process 200 for supporting state migration for the elastic virtualized component 120 of FIG. 1, it is assumed that, prior to the elasticity event, an original message was received at elastic virtualized component 120, routed from component load balancer 121 to component instance 125_{N-1} based on selection of component instance 125_{N-1} for the original message by the component load balancer 121, and processed by component instance 125_{N-1} (thereby resulting in generation and storage of state information for the original message as part of state information 126_{N-1} of component instance 125_{N-1}). The selection of component instance 125_{N-1} for the original message by the component load balancer 121 is based on a load balancing mechanism supported by the component load balancer 121. As discussed above, the load balancing mechanism is based on computation of a hash over at least a portion of the original message. The computation of the hash is based on the number of component instances 125 available in elastic virtualized component 120 prior to the elasticity event (namely, N component instances 125). The component load balancer 121, in response to selection of the component instance 125_{N-1} for the original message, creates a mapping entry in the state information mapping table 123 that maps (1) the value of the original message that is used for selecting the component instance 125_{N-1} (denoted herein as VAL1) to (2) the component instance 125_{N-1}. This is depicted in FIG. 2 as a mapping of VAL1 to component instance 125_{N-1}. This mapping entry indicates that the original message will be processed by component instance 125_{N-1} and, thus, that state information 126_{N-1} of component instance 125_{N-1} includes state information generated based on processing of the original message by component instance 125_{N-1}.

In describing the process 200 for supporting state migration for the elastic virtualized component 120 of FIG. 1, it is further assumed that, as a result of the elasticity event, the hash mapping table 122 of component load balancer 121 is updated based on the modified set of component instances 125 available within elastic virtualized component 120. Namely, hashes computed for messages received after the elasticity event are computed based on the number of component instances 125 available in elastic virtualized component 120 after the elasticity event (e.g., N+1 component instances 125 in the case of a growth event or N−1 component instances 125 in the case of a degrowth event), which is different than the number of component instances 125 available in elastic virtualized component 120 before the elasticity event (namely, N component instances 125), such that different component instances 125 may be selected for the same message value for related messages received before and after the elasticity event, respectively. The entry of the hash mapping table 122 for VAL1 before the elasticity event (mapped to component instance 125_{N-1}, as discussed above) and the entry of the hash mapping table 122 for VAL1 after the elasticity event (mapped to component instance 125₁) are depicted in FIG. 2.

As step 205, elastic virtualized component 120 receives a subsequent message, related to the original message (namely, it also includes a value of VAL1), after the elasticity event. The subsequent message, like the original message, may be received from a traffic source 110. The subsequent message is received by the component load balancer 121 of elastic virtualized component 120.

At step 210, component load balancer 121 selects one of the component instances 125 to which the subsequent message is to be provided. The component load balancer 121 computes a hash over VAL1 and searches the hash mapping table 122 to determine which of the component instances 125 to which the subsequent message is to be provided. As discussed above, modification of the hash mapping table 122 responsive to the growth event results in selection of component instance 125₁ for the subsequent message, even though the original message was directed to component instance 125_{N-1} (and, thus, state information 126_{N-1} of component instance 125_{N-1} includes state information which may be used to process the subsequent message).

At step 215, the component load balancer 121 identifies a component instance 125 storing state information 126 associated with the subsequent message. The component load balancer 121 searches the state information mapping table 123 using the value used by the component load balancer 121 to compute the hash for selection of the component instance 125 to which to route the subsequent message (namely, VAL1) to determine whether a message including that value was previously received and directed to one of the component instances 125. In this case, component load balancer 121 determines that a message including VAL1 (namely, the original message discussed above) was previously received and directed to the component instance 125_{N-1}. It is noted that, in the case in which the state information mapping table 123 does not include an entry having the value used by the component load balancer 121 to compute the hash for selection of the component instance 125 to which to route the a received message (which, in this case, would have been the case when the original message was received), component load balancer 121 creates a new entry for that value in the state information mapping table 123 where the new entry includes a mapping of that value to the component instance 125 selected for the received message (which, again, resulted in the mapping of VAL1 to component instance 125_{N-1} in state information mapping table 123).

At step 220, component load balancer 121 determines whether to trigger migration of state information 126 for use in processing the subsequent message. The component load balancer 121 compares the component instance 125 selected for the subsequent message based on the hash mapping table 122 (i.e., component instance 125₁) to the component instance identified from the state information mapping table 123 (i.e., component instance 125_{N-1}) to determine whether state information 126 needs to be migrated within elastic virtualized component 120 for use in processing the subsequent message. If the component instance 125 selected based on the hash mapping table 122 and the component instance 125 identified from the state information mapping table 123 are the same (which is not the case in FIG. 2), then the state information 126 for use in processing the subsequent message is already available on the component instance 125 to which the subsequent message is being directed and, thus, migration of state information 126 is not needed. If the component instance 125 selected based on the hash mapping table 122 and the component instance 125 identified from the state information mapping table 123 are different (which is the case in FIG. 2, as FIG. 2 is provided to illustrate various embodiments supporting migration of state information 126 between component instances 125 of elastic virtualized component 120), then the state information 126 for use in processing the subsequent message is not already available on the component instance 125 to which the subsequent message is being directed and, thus, migration of state information 126 is needed.

At step 225, component load balancer 121 modifies the subsequent message in a manner for indicating to the component instance 125 selected based on the hash mapping table 122 (i.e., component instance 125₁) that state information for use in processing the subsequent message is available from the component instance 125 identified from the state information mapping table 123 (i.e., component instance 125_{N-1} which maintains state information 126_{N-1} including state information generated based on processing of the original message by component instance 125_{N-1}). The modification of the subsequent message to form the modified subsequent message may be performed by adding an additional header to the subsequent message, adding an additional header field(s) to an existing header of the subsequent message, modifying an existing header field(s) of the subsequent message, or the like. The indication to the component instance 125 selected based on the hash mapping table 122 that state information 126 for use in processing the subsequent message is available from the component instance 125 identified from the state information mapping table 123 may be indicated by a combination of an indicator bit (e.g., “1” indicates that state information is available and “0” indicates that state information is not available, or vice versa) and an identifier of the component instance 125 identified from the state information mapping table 123. The indication to the component instance 125 selected based on the hash mapping table 122 that state information 126 for use in processing the subsequent message is available from the component instance 125 identified from the state information mapping table 123 may be indicated by including, within a particular header field, an identifier of the component instance 125 identified from the state information mapping table 123 that is storing state information (e.g., presence of an identifier indicates that migration of state information 126 needs to be performed and absence of an identifier indicates that migration of state information 126 does not need to be performed). For example, in the case of a SIP message, the indication may be provided by including within the subsequent message a special field (referred to herein as the “Migrate-From” field) that is populated with an identifier of the component instance 125 from which the state information 126 may be retrieved (e.g., an address of the component instance 125 from which the state information 126 may be retrieved or any other suitable information which may be used to retrieve the state information 126). The indication to the component instance 125 selected based on the hash mapping table 122 that state information 126 for use in processing the subsequent message is available from the component instance 125 identified from the state information mapping table 123 may be indicated within the subsequent message in other ways. It will be appreciated that, although primarily depicted and described with respect to embodiments in which the indication of the availability of state information 126 is communicated by modifying the subsequent message to form the modified subsequent message, in at least some embodiments the indication of the availability of state information 126 may be communicated without modifying the subsequent message (e.g., by sending a separate message (including identification of the component instance 125 from which state information is available) from component load balancer 121 to the component instance 125 selected based on the hash mapping table 122). It will be appreciated that, although primarily depicted and described with respect to embodiments in which the indication provided from the component load balancer 121 to the component instance 125 selected based on the hash mapping table 122 is an indication that state information 126 for use in processing the subsequent message is available from the component instance 125 identified from the state information mapping table 123, the indication provided from the component load balancer 121 to the component instance 125 selected based on the hash mapping table 122 also or alternatively may be considered to be an indication that state information 126 for use in processing the subsequent message needs to be retrieved or migrated from the component instance 125 identified from the state information mapping table 123.

At step 230, component load balancer 121 provides the modified subsequent message to component instance 125₁ (namely, the component instance 125 selected based on the hash mapping table 122).

At step 235, component instance 125₁ determines whether the received message (the message received from component load balancer 121, which is the modified subsequent message) indicates that state information 126 for use in processing the received message is available from a different component instance 125 (i.e., other than locally from state information 126₁ of component instance 125₁). In at least some cases, as discussed above, this also may be considered to be a determination as to whether processing of the received message requires retrieval or migration of state information 126 from a different component instance 125 (i.e., other than locally from state information 126₁ of component instance 125₁). The component instance 125₁ determines whether the received message indicates that state information 126 is available by checking the received message for an indication of availability of state information 126. In FIG. 2, the received message that is received by component instance 125₁ is the modified subsequent message provided from component load balancer 121 to component instance 125₁ and, thus, does include an indication that state information 126 is available. The component instance 125₁ also identifies, from the modified subsequent message, the source of state information 126 (namely, component instance 125_{N}). For example, in the case of a SIP message, the determination that the received message indicates that state information 126 is available may be made based on inclusion of the Migrate-From field in the received message and the source of the state information 126 may be determined from the information included within the Migrate-From field of the received message. It is noted that, in an embodiment in which a separate message is used to indicate that state information 126 is available, the determination that the received message indicates that state information 126 is available and the source of the state information 126 may be determined from the separate message.

At step 240, component instance 125_{N+1} sends a state information request message to the component instance 125 indicated in the modified subsequent message (namely, the component instance 125_{N-1}).

In one embodiment, sending the state information request message includes modifying the modified subsequent message to include an indication of a request for state information 126 and sending the modified subsequent message including the indication of the request for state information 126 to component instance 125_{N-1}. The indication of the request for state information 126 may be indicated by a combination of an indicator bit and an identifier of the component instance 125 requesting retrieval of the state information (namely, component instance 125₁). The indication of the request for state information 126 may be indicated by including, within a particular header field, an identifier of the component instance 125 requesting retrieval of the state information 126 (again, component instance 125₁). For example, in the case of a SIP message, indication of the request for state information 126 may be provided by including within the subsequent message a special field (referred to herein as the “Migrate-To” field) that is populated with an identifier of the component instance 125 that is requesting retrieval of the state information 126 (e.g., an address of the component instance 125 that is requesting retrieval of the state information 126 or any other suitable information which may be used to identify the component instance 125 that is requesting retrieval of the state information 126). The indication of the request for state information 126 may be indicated in other ways.

In one embodiment, sending the state information request message includes storing the modified subsequent message at the component instance 125₁ and sending a separate state information request message to the component instance 125_{N-1}. Here, the component instance 125₁ maintains (e.g., stores, queues, buffers, or the like) the modified subsequent message until receiving the requested state information 126 from the component instance 125_{N}, at which time component instance 125₁ may process the modified subsequent message based on the received state information 126 as discussed in additional detail below. The state information request message includes an identifier of the component instance 125 requesting retrieval of the state information (namely, component instance 125₁).

At step 245, component instance 125_{N-1} retrieves, from the state information 126_{N-1} maintained by the component instance 125_{N-1}, state information 126 that is associated with the modified subsequent message (and, thus, which may be used to process the modified subsequent message). Here, it is assumed that component instance 125_{N-1} has identified the state information request message as being a request to retrieve state information (as opposed to a message directed to component instance 125_{N-1} by the component load balancer 121 for processing by component instance 125_{N-1}). The component instance 125_{N-1} may identify the state information request message as being a request to retrieve state information based on information included within the state information request message (e.g., based on detection of an indicator set in a particular way, based on inclusion of a particular header field (e.g., Migrate-To in the SIP example discussed herein) within the state information request message, or the like).

At step 250, component instance 125_{N-1} responds to the state information request message by sending a state information response message, including the retrieved state information 126 that is associated with the modified subsequent message, to the component instance 125 indicated in the state information request message (namely, the component instance 125₁).

In one embodiment, in which the state information request message is a modified version of the modified subsequent message (modified to indicate that component instance 125₁ is requesting state information 126), the state information response message is also a modified version of the modified subsequent message. In this case, the modified subsequent request message includes the state information for use by component instance 125₁ in processing the modified subsequent message.

In one embodiment, in which the state information request message is a separate message, rather than being a modified version of the modified subsequent message, the state information response message is also a separate message that includes the state information for use by component instance 125₁ in processing the modified subsequent message.

The state information 126 associated with the modified subsequent message may be included within the state information response message in any suitable manner. The state information 126 associated with the modified subsequent message may be included within the state information response message in one or more existing header fields, one or more new header fields, one or more existing headers, one or more existing headers, as part of a payload, or the like, as well as various combinations thereof. For example, in the case of a SIP message, the state information 126 associated with the modified subsequent message may be included within the state information response message by serializing the state information 126 associated with the modified subsequent message and inserting the serialized state information 126 in a special field (referred to herein as the “Migrate-Data” field) that is inserted into the SIP message.

The state information 126 associated with the modified subsequent message is deleted from the state information 126_{N-1} of component instance 125_{N-1}, because the modified subsequent message and other subsequent related messages will be routed to and processed by component instance 125₁ that is currently indicated in the hash mapping table 122 of component load balancer 121 for that set of related messages (assuming no change in hash mapping table 122, or at least no change that impacts routing of related messages by component load balancer 121). The deletion of the retrieved state information 126 associated with the modified subsequent message from the state information 126_{N-1} of component instance 125_{N-1} indicates that the state information 126 has actually been migrated to component instance 125₁ (as opposed to copied to component instance 125₁, although it will be appreciated that copying rather than migration may be supported where necessary or desirable).

At step 255, component instance 125₁ processes the modified subsequent message based on the state information 126, associated with the modified subsequent message, retrieved from the component instance 125_{N-1}. The processing of the modified subsequent message based on the state information 126 associated with the modified subsequent message may result in generation of a response message corresponding to the subsequent message received at elastic virtualized component 120. Here, it is assumed that component instance 125₁ generates a response message corresponding to the subsequent message received at the elastic virtualized component 120. The state information 126 associated with the modified subsequent message is stored as part of the state information 126₁ of component instance 125₁, because the modified subsequent message and other subsequent related messages will be routed to and processed by component instance 125₁ that is currently indicated in the hash mapping table 122 of component load balancer 121 for that set of related messages (assuming no change in hash mapping table 122, or at least no change that impacts routing of related messages by component load balancer 121).

At step 260, component instance 125₁ propagates the response message corresponding to the subsequent message received at the elastic virtualized component 120. The response message may be propagated to the device or element from which the original message originated (e.g., a traffic source 110), to a device or element different than the device or element from which the original message originated, or the like, as well as various combinations thereof.

It will be appreciated that, although omitted from FIG. 2 for purposes of clarity, elastic virtualized component 120 may be configured to perform other functions in support of elasticity events.

In at least some embodiments, in which an original message is received and processed by a first component instance 125, a first subsequent message related to the original message is received by a second component instance 125, and a second subsequent message related to the original message is received by the second component instance 125 while the second component instance 125 is in the process of retrieving state information 126 from the first component instance 125 responsive to the first subsequent message, the second component instance 125 may be configured to store the second subsequent message until receiving the migrated state information 126 from the first component instance 125, at which time the second component instance 125 may then process the first and second subsequent messages based on the migrated state information 126.

In at least some embodiments, in which the elasticity event causes termination of an existing component instance 125 (e.g., component instance 125_{N-1}, as discussed above), component load balancer 121 removes the existing component instance 125 from the hash mapping table 122 (so as to force selection of other component instances 125 to handle new messages received at the elastic virtualized component 120) and also terminates and removes the existing component instance 125 from elastic virtualized component 120. The termination and removal of the existing component instance 125 from the elastic virtualized component 120 causes a loss of any state information 126 which may have been stored by the existing component instance 125. It is noted that the discarding of the residual state information 126 still being stored by the existing component instance 125 may result in errors (e.g., dropped calls, dropped sessions, or the like). While this may be acceptable in some implementations, there also may be implementations in which discarding of the residual state information 126 still being stored by the existing component instance 125 should be avoided.

In at least some embodiments, in which the elasticity event causes termination of an existing component instance 125 (e.g., component instance 125_{N-1}, as discussed above), component load balancer 121 removes the existing component instance 125 from the hash mapping table 122 (so as to force selection of other component instances 125 to handle new messages received at the elastic virtualized component 120), but termination and removal of the existing component instance 125 from elastic virtualized component 120 is delayed (or, stated differently, the existing component instance 125 is kept alive) until a condition is satisfied. The condition may be migration of all of the state information 126 of the existing component instance 125 out of the existing component instance 125, migration of a certain portion of the state information 126 of the existing component instance 125 out of the existing component instance 125 (e.g., 60%, 85%, or the like), expiration of a “termination time” set responsive to the determination to terminate the existing component instance 125, or the like, as well as various combinations thereof.

In at least some embodiments in which the existing component instance 125 is kept alive until detection of the condition which triggers termination and removal of the existing component instance 125 from the elastic virtualized component 120, a first subsequent message (of a set of related messages having associated state information 126 stored on the existing component instance 125) received at the elastic virtualized component 120 may be handled as depicted and described with respect to process 200 of FIG. 2 (e.g., the existing component instance receives a state information request message and responds with a corresponding state information response message).

In at least some embodiments in which the existing component instance 125 is kept alive until detection of the condition which triggers termination and removal of the existing component instance 125 from the elastic virtualized component 120, based on detection of the condition which triggers termination and removal of the existing component instance 125 from elastic virtualized component 120, a determination may be made as to whether the existing component instance 125 is still storing state information 126 for one or more sets of related messages (it is noted that such a determination may not be necessary or relevant for certain condition types, such as where the existing component instance 125 is kept alive until all of the state information 126 of the existing component instance 125 has been migrated). In at least some embodiments, based on a determination that the existing component instance 125 is not still storing state information 126, the existing component instance 125 may be terminated and removed from elastic virtualized component 120. In at least some embodiments, based on a determination that the existing component instance 125 is still storing some state information 126, the residual state information 126 still being stored by the existing component instance 125 may be handled appropriately. The handling of the residual state information 126 still being stored by the existing component instance 125 may include one or more of discarding some or all of the residual state information 126, performing a forced migration of some or all of the residual state information 126 (where such a migration may be considered to be forced because it is not responsive to receipt of a related message(s) for the residual state information 126), or copying some or all of the residual state information 126 from the existing component instance 125 to one or more elements (e.g., one or more component instances 125, one or more external elements external to elastic virtualized component 120, or the like). The existing component instance 125 may then be terminated and removed from elastic virtualized component 120 following completion of the handling of the residual state information 126 of the existing component instance 125. The discarding of residual state information 126 still being stored by the existing component instance 125 may result in errors (e.g., dropped calls, dropped sessions, or the like). The forced migration of residual state information 126 still being stored by the existing component instance 125 may be performed in various ways. For example, forced migration of the residual state information 126 still being stored by the existing component instance 125 may include one or more of migrating at least some of the residual state information 126 by distributing it across some or all of the remaining component instances 125 of the elastic virtualized component 120, migrating at least a portion of the residual state information 126 to one or more elements external to the elastic virtualized component 120 (e.g., one or more databases or other storage locations), or the like, as well as various combinations thereof. The forced migration of the residual state information 126 still being stored by the existing component instance 125 may be triggered by providing to component load balancer 121 fake messages that are configured to cause the migration of the residual state information 126 (e.g., using a process similar to the process 200 of FIG. 2), using a communication protocol to control migration of the residual state information 126, or the like, as well as various combinations. The fake messages that are configured to cause the migration of the residual state information 126 also may be configured so as not to impact the residual state information 126 or any other state information 126 of the elastic virtualized component 120 (e.g., reregistering an already registered client or the like). The fake messages that are configured to cause the migration of the residual state information 126 may be generated or provided to component load balancer 121 from an element(s) located outside of elastic virtualized component 120, from an element(s) located within elastic virtualized component 120, or the like, as well as various combinations thereof. The forced migration of the residual state information 126 still being stored by the existing component instance 125 will likely prevent errors (e.g., dropped calls, dropped sessions, or the like), at the expense of additional overhead associated with performing the forced migration of the residual state information 126 still being stored by the existing component instance 125. The copying of residual state information 126 from the existing component instance 125 to one or more elements may performed in a manner for enabling the one or more elements to support further natural migration of the residual state information 126 from the one or more elements to existing component instances 125 of elastic virtualized component 120 (e.g., using a process similar to process 200 of FIG. 2, but in which the one or more elements receive state information request messages and respond with corresponding state information response messages). In at least some embodiments, the determination as to the manner in which to handle the residual state information 126 (e.g., whether to discard, migrate, or copy residual state information 126) may be based on various factors (e.g., likelihood of errors or failures, severity of errors or failures, the amount of residual state information 126 still being stored by the existing component instance 125, the average length of calls or sessions for which residual state information 126 is maintained, or the like, as well as various combinations thereof). In at least some embodiments, migration or copying of residual state information 126 (e.g., the element(s) to which the residual state information 126 is migrated or copied, the manner in which the residual state information 126 is migrated or copied, or the like) may be based on various factors (e.g., the type of residual state information 126, the availability of storage space on element(s) to which the residual state information 126 is to be migrated or copied, the average length of calls or sessions for which residual state information 126 is maintained, or the like, as well as various combinations thereof). It is noted that, in at least some embodiments, at least a portion of the state information 126 of an existing component instance 125 that is being terminated may not need to be handled as discussed above, as the state information 126 may be removed after expiring due to natural non-interactivity timeouts (e.g., a SIP registration expires after a configurable time-out).

In at least some embodiments, in which the elasticity event causes termination of an existing component instance 125 (e.g., component instance 125_{N-1}, as discussed above), the existing component instance 125 continues to operate while the state information 126 of the existing component instance 125 is copied to an external element, external to elastic virtualized component 120, which may use the copied state information 126 in order to process messages after the existing component instance 125 is terminated and removed from elastic virtualized component 120. It will be appreciated that such embodiments may enable the existing component instance 125 to be terminated and removed immediately or nearly immediately (e.g., following copying of the state information 126 to the external element). The external element may be a database, a VM hosted in a cloud environment (e.g., in the same cloud environment in which the elastic virtualization component 120 is hosted), or the like, as well as various combinations thereof. The external element may be considered to form part of the capacity of elastic virtualized component 120. In this embodiment, component load balancer 121 does not modify the hash mapping table 122 responsive to the determination that the existing component instance 125 is to be terminated; rather, the existing component instance 125 is maintained within the hash mapping table 122 and the component load balancer 121 continues to send received messages to the existing component instance 125 while the existing component instance 125 copies its state information 126 to the external element. The copying of state information 126 from the existing component instance 125 to the external element includes copying of any new state information 126 that is generated based on processing of messages received at the existing component instance 125 while the existing component instance 125 copies its state information 126 to the external element. The component load balancer 121, following copying of its state information 126 to the external element, removes the existing component instance 125 from hash mapping table 122, updates the information mapping table 124 by replacing references to the existing component instance 125 with references to the external component (or marking references to the existing component interface 125 as being redirected to the external element), and terminating and removing the existing component instance 125 from elastic virtualized component 120. The elastic virtualized component 120 may then operate in a manner similar to process 200 of FIG. 2, but in which the state migration request message is sent from a component instance 125 to the external element (rather than to another one of the component instances 125) and the associated state information response message (that includes the state information 126 that was requested by the component instance 125) is sent from the external element to the component instance 125. The component load balancer 121, upon receiving a subsequent message for which an entry of state information mapping table 123 indicates that the state information 126 is maintained in the external element, modifies the subsequent message to include an indication that state information 126 for the subsequent message is available from the external element (e.g., a “Migrate-From” field including an identification of the external element to which the state information 126 was migrated) and sends the modified subsequent message to the component instance 125 selected for the subsequent message based on hash mapping table 122 (e.g., component instance 125₁ in the example of FIG. 2).

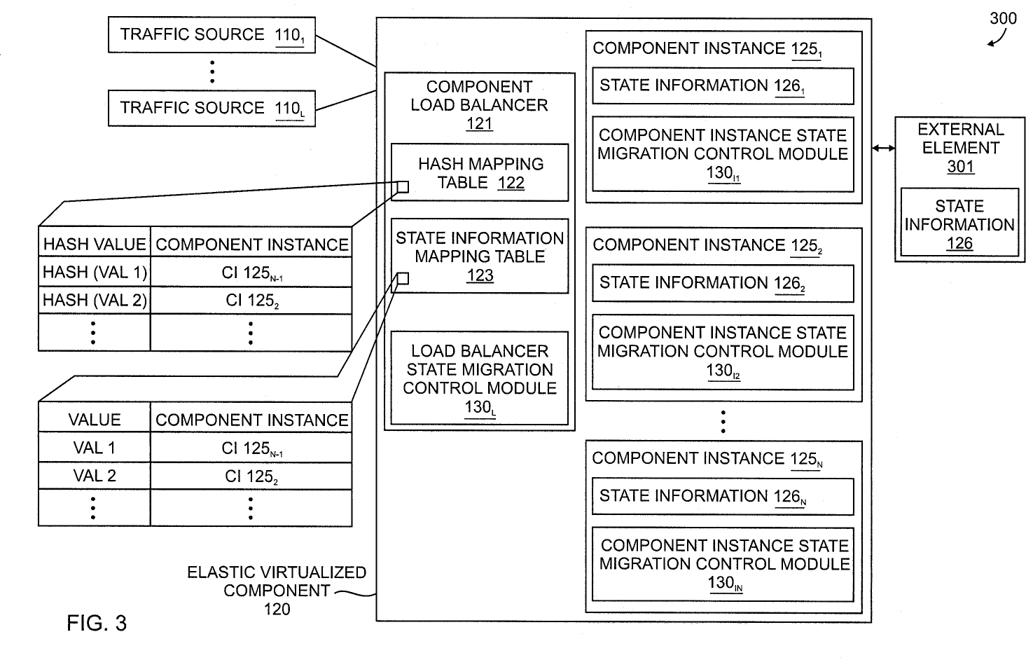

FIG. 3 depicts an exemplary system including the elastic virtualized component of FIG. 1 and an external element configured for supporting migration of state information of the elastic virtualized component of FIG. 1. As depicted in FIG. 3, system 300 is similar to system 100 of FIG. 1, while also including an external element 301 which may be configured to perform various functions discuss herein as being performed by external elements for supporting migration of state information 126 for elastic virtualized component 120 (e.g., storing state information 126 migrated out of component instances 125, responding to requests for state information 126 that are received from component instances 125, or the like, as well as various combinations thereof). The external element 301 may be a physical server, a virtual server, a VM, a database, or the like, as well as various combinations thereof. The communication between the external element 301 and the elastic virtualized component 120 may be via any suitable communication paths (e.g., within a datacenter, between datacenters, between a datacenter(s) hosting elastic virtualized component 120 and the external component 301, via various types of communication networks, or the like, as well as various combinations thereof).

As discussed hereinabove, elastic virtualized component 120 may be used to provide virtualization of various types of functions, one of which is virtualization of the P-CSCF and S-CSCF components of an IMS architecture. For example, virtualization of the P-CSCF and S-CSCF components of an IMS architecture may be realized modifying the Kamailio open-source IMS Core software and the Linux Virtual Server (LVS) SIP scheduling algorithms, so as to obtain elastic virtualized (Kamailio-based) P-CSCF and S-CSCF components. LVS may be used as load balancer with the above described application-specific logic for Kamailio. The elastic virtualized P-CSCF and S-CSCF components may be configured to support migration of data (e.g., state information) by adding, to the SIP messages triggering the migration itself, additional SIP header fields (defined in a custom way as needed) in order to transmit the information to be moved across instances. It is noted that, for purposes of clarity and simplicity, only implementation of elastic virtualized P-CSCF and S-CSCF components supporting simple SIP scenarios (e.g., SIP registrations and simple calls) are discussed; however, the various embodiments depicted and described herein also may be used to support implementation of the elastic virtualized P-CSCF and S-CSCF components to support various other types of SIP scenarios (including more complex SIP scenarios). The implementation of elastic virtualized P-CSCF and S-CSCF components supporting SIP registrations and simple calls may include support for migration of the following data when the hash mapping in the component load balancer changes may include: (1) for the P-CSCF: user IMPU, user contact information (SIP Contact: header), S-CSCF URI, and registration state, and (2) for S-CSCF: user IMPU, user contact information (SIP Contact: header), P-CSCF URI, and registration state. It will be appreciated that implementation of elastic virtualized P-CSCF and S-CSCF components supporting more complex scenarios may include support for migration of other data (e.g., within an elastic virtualized S-CSCF component, migration of data regarding subscription data received from the HSS). The elastic virtualized P-CSCF and S-CSCF components may be configured such that the URIs of the P-CSCF and the S-CSCF are equal, respectively, to the URIs of the component load balancer of the P-CSCF and the component load balancer of the S-CSCF, such that each SIP message directed to a P-CSCF/S-CSCF is forced to pass through the proper component load balancer and, thus, may be forwarded to the correct component instance according to component instance selection mapping (which, as discussed herein, that can change dynamically after growth and degrowth operations). The dialogue/session related information in P-CSCF and S-CSCF components is generally managed using the Route SIP headers, where the URI of the particular instance is stored along with an identifier used to track the state (e.g., a P-CSCF should be able to distinguish between an INVITE request received from the caller UA and one directed to the callee UA). The component instances of the elastic virtualized P-CSCF and S-CSCF components may be configured to insert, within the Router header, the URIs of the component load balancers of the elastic virtualized P-CSCF and S-CSCF components (rather than their own respective URIs), respectively. In this manner, each component instance of the elastic virtualized P-CSCF and S-CSCF components is able to correctly manage and bring forward even a dialogue/session that has begun on another instance (namely, if the growth or degrowth operation occur in the middle of a single dialogue/session). The modifications to the load balancers in order to provide the component load balancers of the elastic virtualized P-CSCF and S-CSCF components may include: (1) modification of the scheduling algorithms, as realized in the ip_vs_sh and ip_vs_dh kernel modules of LVS (which is capable of load-balancing IP traffic based on hashing the source or destination IP address)” and (2) adding a stateful mapping (referred to herein as the state information mapping table) to the component load balancer so that the kernel module can remember where requests pertaining to a given user were directed to last time. If the new configuration of the component load balancer due to the addition or removal of component instances changes the stateful mapping, the change will be detected the first time that a message has to be forwarded to the newly assigned component instance. In this case, as described above, the modified kernel modules add an additional SIP header (e.g., Migrate-From) to the message and the message is then forwarded to the new P-CSCF or S-CSCF component instance. The additional SIP header that is added to the message points back to the previous P-CSCF or S-CSCF component instance (which still has state information about that specific user) and, thus, the new P-CSCF or S-CSCF component instance, recognizing the additional SIP header, can retrieve the data from the previous P-CSCF or S-CSCF component instance. For degrowth, Kamailio may be modified to be able to load on-demand records from an external DB (e.g., MySQL, Cassandra, or the like) when the corresponding records are not found in memory (it is possible to directly trigger the recovery from the external DB based on the receipt of a header field indicating that the records should be recovered from the external DB (e.g., inclusion of a Migrate-FromDB header), while in-memory records are dumped into the external DB at server shut-down time or as a reaction to a specific command.

In at least some embodiments, the capability for handling state migration for an elastic virtualized component obviates the need to store state information in external databases, which typically introduces computational, network, and storage overheads that may result in or at least risk degradation of the performance that is achievable with a given set of component instances and, thus, leading to significantly lower throughputs and higher latencies. In at least some embodiments, the capability for handling state migration for an elastic virtualized component supports elasticity while eliminating, or at least minimizing or reducing, dropping of requests to be handled by the elastic virtualized component (which may translate to preventing or reducing the number of dropped sessions or calls in the case of network function virtualization for at least some network functions). Various other advantages of the capability for handling state migration for elastic virtualized components are contemplated.

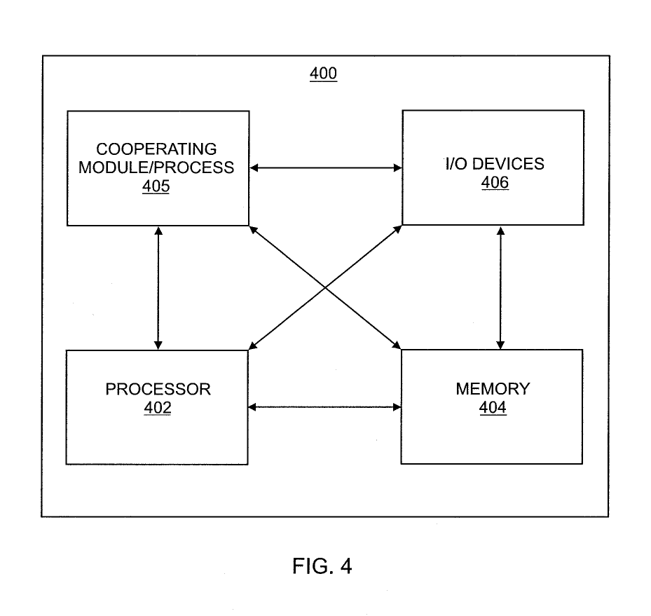

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 400 depicted in FIG. 4 provides a general architecture and functionality suitable for implementing functional elements described herein and/or portions of functional elements described herein. For example, the computer 400 provides a general architecture and functionality suitable for implementing a traffic source 110, a portion of a traffic source 110, elastic virtualized component 120, a portion of elastic virtualized component 120, a group of component instances 125, a component instance 125, a portion of a component instance 125, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, stored within a memory within a computing device operating according to the instructions, or the like, as well as various combinations thereof.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus configured to support an elastic virtualized component, the apparatus comprising:
a processor and a memory communicatively connected to the processor, the processor configured:
receive, at a first component instance of the elastic virtualized component, a message to be processed by the first component instance, wherein the received message includes information indicative that state information associated with the received message is available from a second component instance of the elastic virtualized component; and
propagate, from the first component instance toward the second component instance, a state information request message configured to request migration of the state information from the second component instance to the first component instance.

2. The apparatus of claim 1, wherein the processor is configured to:
determine, based on inclusion of an identifier of the second component instance in the received message, that state information associated with the received message is available from the second component instance; and
generate the state information request message based on a determination that state information associated with the received message is available from the second component instance.

3. The apparatus of claim 1, wherein the state information request message comprises a modified version of the received message.

4. The apparatus of claim 1, wherein the processor is configured to:
generate the state information request message by modifying the received message to include an identifier of the first component instance.

5. The apparatus of claim 4, wherein the processor is configured to:
receive, from the second component instance, a state information response message including the state information, wherein the state information response message comprises a modified version of the state information request message;
extract the state information from the state information response message; and
process the received message based on the state information.

6. The apparatus of claim 1, wherein the state information request message comprises a message separate from the received message.

7. The apparatus of claim 1, wherein the processor is configured to:
store the received message pending receipt of the state information from the second component instance;
receive, from the second component instance, a state information response message including the state information; and
process the received message based on the state information.

8. The apparatus of claim 5, wherein the processor is configured to:
receive the state information from the second component instance; and
store the state information at the first component instance.

9. The apparatus of claim 1, wherein the processor is configured to:
receive, at the first component instance prior to receipt of the state information from the second component instance, a second message to be processed by the first component instance;
store the second received message at the first component instance;
receive the state information from the second component instance; and
process the received message and the second received message based on the state information.

10. A method for supporting an elastic virtualized component, the method comprising:
receiving, at a first component instance of the elastic virtualized component, a message to be processed by the first component instance of the elastic virtualized component, wherein the received message includes information indicative that state information associated with the received message is available from a second component instance of the elastic virtualized component; and
propagating, from the first component instance toward the second component instance, a state information request message configured to request migration of the state information from the second component instance to the first component instance.

11. An apparatus configured to support propagation of messages for processing by an elastic virtualized component, the apparatus comprising:
a processor and a memory communicatively connected to the processor, the processor configured to:
receive a message intended for processing by the elastic virtualized component, the elastic virtualized component comprising a set of virtual component instances;
select a first component instance of the elastic virtualized component for the received message;
modify the received message, based on a determination that state information associated with the received message is stored by a second component instance of the elastic virtualized component, to form a modified message including information indicative of the second component instance storing the state information associated with the received message; and
propagate the modified message toward the first component instance.

12. The apparatus of claim 11, wherein the processor is configured to select the first component instance for the received message based on a value included within the received message.

13. The apparatus of claim 11, wherein the processor is configured to select the first component instance for the received message based on a hash computed over information from the received message.

14. The apparatus of claim 13, wherein the processor is configured to select the first component instance for the received message based on a mapping between the hash and the first component instance.

15. The apparatus of claim 13, wherein the processor is configured to determine that state information associated with the received message is stored by the second component instance based on a mapping between the information from the received message over which the hash is computed and the second component instance.

16. The apparatus of claim 15, wherein the processor is configured to:
based on propagation of the modified message toward the first component instance, modify the mapping to form a modified mapping between the information from the received message over which the hash is computed and the first component instance.

17. The apparatus of claim 11, wherein the information indicative of the second component instance storing the state information associated with the received message comprises an identifier of the second component instance.

18. The apparatus of claim 11, wherein, to modify the received message to form the modified message, the processor is configured to at least one of add a new header to the received message, add a new header field to the received message, or modify an existing header field of the received message.

19. The apparatus of claim 11, wherein the processor is configured to:
maintain mapping information comprising, for each component instance in the set of component instances, a mapping of one or more hash values to the respective component instance in the set of component instances; and
modify at least a portion of the mapping information responsive to an elasticity event that modifies a number of component instances in the set of component instances of the elastic virtualized component.

20. A method for supporting processing of messages by an elastic virtualized component, the method comprising:
receiving, by a processor, a message intended for processing by the elastic virtualized component, the elastic virtualized component comprising a set of virtual component instances;
selecting a first component instance of the elastic virtualized component for the received message;
modifying the received message, based on a determination that state information associated with the received message is stored by a second component instance of the elastic virtualized component, to form a modified message including information indicative of the second component instance storing the state information associated with the received message; and
propagating the modified message toward the first component instance.
